(19) United States
(12) Patent Application Publication
(10) Pub. No.: US 2008/0267256 A1
(43) Pub. Date: Oct. 30, 2008

(54) INFORMATION PROCESSING APPARATUS AND CONTROL METHOD OF PROCESSOR CIRCUIT

(75) Inventors: Gen Watanabe, Askishima-shi (JP); Tsuyoshi Nishida, Askishima-shi (JP); Kazuyoshi Kuwahara, Akiruno-shi (JP); Hajime Sonobe, Tachikawa-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/110,230

(22) Filed: Apr. 25, 2008

(30) Foreign Application Priority Data
Apr. 27, 2007 (JP) 2007-120098

(51) Int. Cl. G01K 13/00

(52) U.S. Cl. 374/141; 374/E13.001

(57) ABSTRACT

According to one embodiment, an information processing apparatus comprises a plurality of temperature transmission sections provided in each of first and second semiconductor circuits, and configure to transmit first measured temperature of one of the first and second semiconductor circuits to the other of first and second semiconductor circuits when the first measured temperature is higher than a threshold temperature, and a plurality of operation speed varying sections provided in each of the first and second semiconductor circuits configure to reduce operation speed of the processor circuit possessed by the other of first and second semiconductor circuits, when the received first measured temperature is higher than the second measured temperature of the other of the first and second semiconductor circuits.

### CROSS-REFERENCE TO RELATED APPLICATIONS

This application is based upon and claims the benefit of priority from Japanese Patent Application No. 2007-120098, filed Apr. 27, 2007, the entire contents of which are incorporated herein by reference.

### BACKGROUND

1. Field

One embodiment of the present invention relates to information processing apparatus and a control method of the processor circuit.

2. Description of the Related Art

Presently, with the development of manufacturing equipments of semiconductor devices, it has become possible to provide a plurality of processor circuits in one semiconductor device.

Semiconductor devices of today have a problem in rise of temperature. If the temperature of a semiconductor device becomes high, it causes operational defects, or, at worst, leads to destruction. Suppressing temperature rise of the semiconductor device is therefore necessary.

There is a related art disclosing a control method of a processor wherein a plurality of operational points, which are combinations of transitionable parallel usage level and transitionable operating frequency of a plurality of processing blocks provided inside a processor, are switched with reference to a table on which candidate operational points with respect to the parallel usage level are registered (Jpn. Pat. Appln. KOKAI Publication No. 2006-11548).

According to the above art, there are provided preset processing tables for respective processors, and tasks are plannedly allocated for controlling temperature. However, in order to realize this, user applications should be designed in consideration of the above configuration. At present, there are a great number of user applications, and it is difficult to redesign user applications now in use.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram for showing a system configuration according to one embodiment of the present invention;

FIG. 2 is an exemplary block diagram for showing a configuration of processor group according to one embodiment of the present invention;

FIG. 3 is an exemplary block diagram for showing a configuration of a control section according to one embodiment of the present invention; and

FIG. 4 is an exemplary flow chart indicating procedures of temperature control processing according to one embodiment of the present invention.

### DETAILED DESCRIPTION

Various embodiments according to the invention will be described hereinafter with reference to the accompanying drawings. In general, according to one embodiment of the invention, an information processing apparatus comprising a first semiconductor circuit having a first processor circuit, and a second semiconductor circuit having a second processor circuit, the information processing apparatus comprises a first temperature measurement section provided in the first semiconductor circuit and configure to measure temperature of the first semiconductor circuit, a second temperature measurement section provided in the second semiconductor circuit and configure to measure temperature of the second semiconductor circuit, a plurality of temperature transmission sections provided in each of the first and second semiconductor circuits, and configure to transmit first measured temperature of one of the first and second semiconductor circuits, which is measured by the one of the first and second temperature measurement sections, to the other of first and second semiconductor circuit when the first measured temperature is higher than a threshold temperature, a plurality of temperature comparison sections provided in each of the first and second semiconductor circuits, and configure to compare the first measured temperature and a second measured temperature measured by the temperature measurement section of the other of first and second semiconductor circuits, when the other of first and second semiconductor circuit received the first measured temperature transmitted by the one of the temperature transmission sections, and a plurality of operation speed varying sections provided in each of the first and second semiconductor circuits configure to reduce operation speed of the processor circuit possessed by the other of first and second semiconductor circuits, when the received first measured temperature is higher than the second measured temperature.

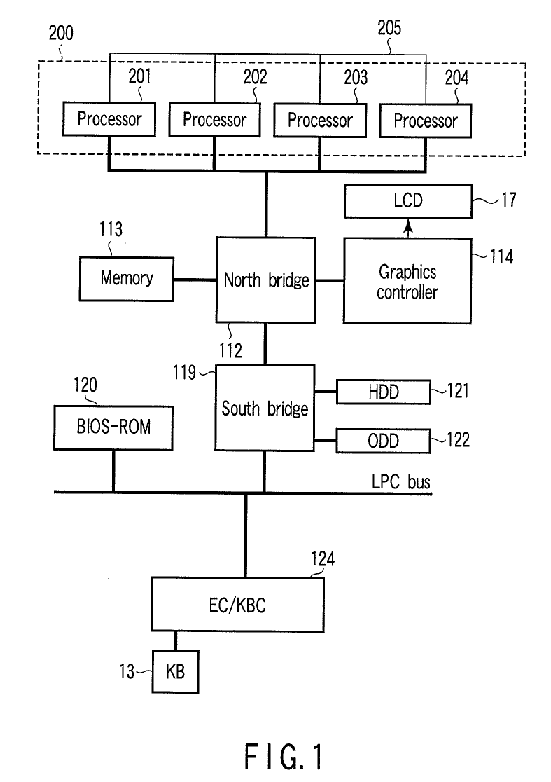

First of all, a configuration of an information processing apparatus according to one embodiment of the present invention will be described with reference to FIG. 1. The information processing apparatus according to the embodiment is realized as a notebook type portable personal computer 10, which is battery drivable. FIG. 1 is a block diagram for indicating a system configuration example of the personal computer 10.

The computer 10 comprises, as shown in FIG. 1, a processor group 200, a north bridge 112, a main memory 113, a graphics controller 114, a south bridge 119, a BIOS-ROM 120, a hard disk drive (HDD) 121, an optical disk drive (ODD) 122, and an embedded controller/keyboard controller IC (EC/KBC) 124.

The processor group 200 is a group of processors provided for controlling operations of the computer 10, and the processor group 200 executes an operating system (OS) and various application programs loaded into the main memory 113 from the HDD 121. The OS has a window system for displaying a plurality of windows on a display screen of the computer. In the present embodiment, the processor group 200 includes four processor circuits 201-204. The processor circuits 201-204 are connected with each other via a temperature management serial bus 205, which is independent from a bus for connecting the north bridge 112 and the processor circuits 201-204. Communications is performed between each of the processor circuits 201-204 via the temperature management serial bus 205.

One example of the processor group 200 is a so-called a multicore processor, configured in such a manner that a plurality of processors are provided on a die (semiconductor chip) formed with one silicon substrate. Also, another example of the processor group 200 is a processor configured in such a manner that a plurality of independent processors is packaged. Furthermore, still another example of the processor group 200 is a plurality of processors mounted on one board.

Incidentally, processor circuits of the processor group 200 need not be same processor circuits that different processor circuits may be used. For instance, one processor circuit may be what is called a CPU (Central processing Unit) and another processor circuit may be an accelerator for executing predetermined processing. Examples of processing executed by an accelerator are: numeric operation-centric transactions; graphic and media processing; data mining and encryptions; compressions; and XML/Java.

The processor group 200 also executes a system BIOS (Basic Input Output System) stored in the BIOS-ROM 120. The system BIOS is a program for a hardware control.

The north bridge 112 is a bridge device for connecting a local bus and the south bridge provided in the processor group 200. The north bridge 112 also incorporates a main controller for access controlling the main memory 113. Furthermore, the north bridge 112 has a function of communicating with the graphics controller 114 via an AGP (Accelerated Graphics Port) bus or the like.

The graphics controller 114 is a display controller for controlling an LCD 17, which is used as a display monitor of the computer 10. The graphics controller 114 has a video memory (VRAM), and generates picture signals, out of display data in the VRAM drawn by OS/application programs, for forming display images to be displayed on the LCD 17.

The south bridge 119 controls each of devices on an LPC (Low Pin Count) bus. Also, the south bridge 119 incorporates an IDE (Integrated Drive Electronics) controller for controlling the HDD 121 and the ODD 122. Furthermore, the south bridge 119 has a function for access controlling the BIOS-ROM 120.

The embedded controller/keyboard controller IC (EC/KBD) 124 is one-chip microcomputer, on which an embedded controller for power supply control and radiation control, and a keyboard controller for controlling a keyboard (KB) 13 are integrated.

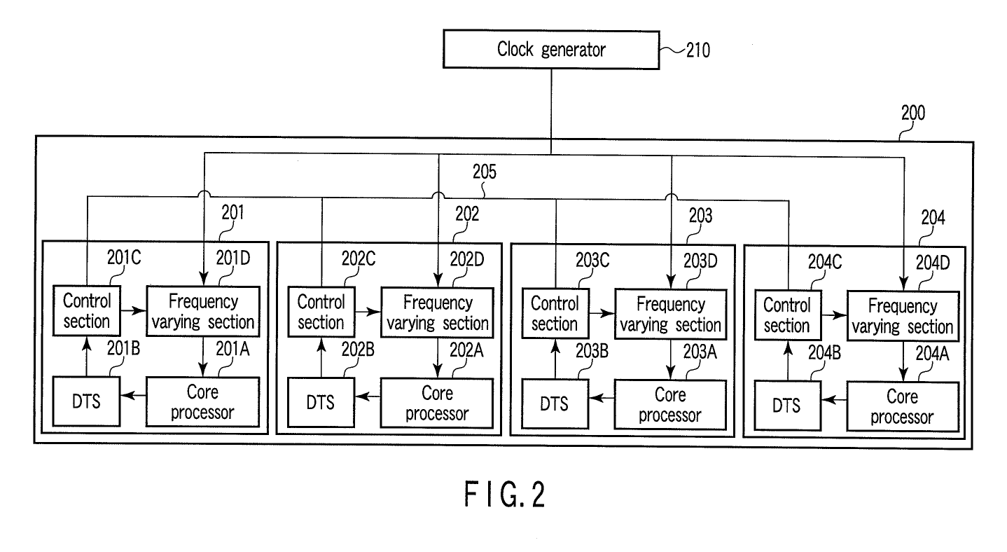

Next, a configuration of the processor group 200 will be explained with reference to the FIG. 2. FIG. 2 is the block diagram indicating a configuration of the processor group according to one embodiment of the present invention.

As shown in FIG. 2, the processor circuits 201, 202, 203, and 204 respectively have core processors 201A, 202A, 203A, and 204A for executing OS and various applications. The processor circuits 201, 202, 203, and 204 respectively have DTS (Digital Thermal Sensors) 201B, 202B, 203B, and 204B for measuring temperatures of respective processor circuits. The processor circuits 201, 202, 203, and 204 respectively have control sections 201C, 202C, 203C, and 204C for performing control based on respective temperatures of the DTS 201B, 202B, 203B, and 204B. The control sections 201C, 202C, 203C, and 204C are able to communicate with each other via the temperature management serial bus 205 provided inside the processor group 200.

The processor circuits 201 to 204 respectively have frequency varying sections 201D to 204D. Each of the frequency varying sections 201D to 204D varies clock frequency supplied from a clock generator 210 based on setting of the corresponding frequency control sections 201C to 204C, and supplies the varied clock frequency to the corresponding core processors 201A to 204A.

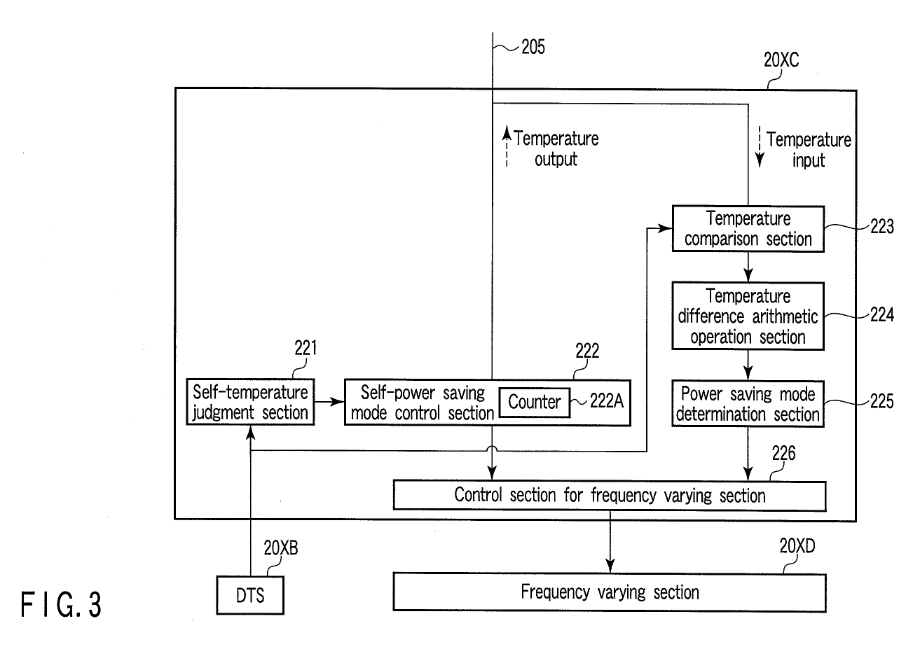

Next, a configuration of the control section 20XC (X=1 to 4) will be explained with reference to FIG. 3. FIG. 3 is the block diagram indicating a configuration of the control section according to one embodiment of the present invention.

The control section 20XC (X=1 to 4) comprises a self-temperature judgment section 221, a self-power saving mode control section 222, a temperature comparison section 223, a temperature difference arithmetic operation section 224, and a power saving mode determination section 225.

The self-temperature judgment section 221 judges whether or not any of the semiconductor circuits in the semiconductor chip should be switched to a power saving condition, based on measured temperature of the DTS 20XB (X=1 to 4).

The self-power saving mode control section 222 judges whether or not its own semiconductor circuit should be switched to a power saving condition, based on communications with other semiconductor circuits via the bus 205.

The self-power saving mode control section 222 has a counter 222A, and the control section 222 correlates values of the counter 222A to other semiconductor circuits. Correlations between count values of the counter 222A and the processor circuits are arranged in such a manner that the smaller a count value is, the shorter a distance between processor circuits is. Examples of the Correlations between the processor circuits and the counter values of semiconductor circuit-by-semiconductor circuit are shown below.

Case of the Processor Circuit 201
Count value=1: Processor circuit 202
Count value=2: Processor circuit 203
Count value=3: Processor circuit 204

Case of the Processor Circuit 202
Count value=1: Processor circuit 201
Count value=2: Processor circuit 203
Count value=3: Processor circuit 204

Case of the Processor Circuit 203
Count value=1: Processor circuit 202
Count value=2: Processor circuit 204
Count value=3: Processor circuit 201

Case of the Processor Circuit 204
Count value=1: Processor circuit 203
Count value=2: Processor circuit 202
Count value=3: Processor circuit 201

The temperature comparison section 223 compares its own measured temperature with a temperature output from another semiconductor circuit, and determines whether or not to have its own processor circuit switched to a power saving mode. If it is determined that its own processor circuit is not able to be switched to a power saving mode, the temperature comparison section 223 reports to the self-power saving mode control section 222. If it is determined that its own processor circuit is able to be switched to a power saving mode, the temperature comparison section 223 reports its own measured temperature and the temperature of the other semiconductor circuit to the temperature difference arithmetic operation section 224.

The temperature difference arithmetic operation section 224 performs an arithmetic operation for obtaining a difference ΔT of the two reported temperatures, and reports the temperature difference ΔT to the power saving mode determination section 225 of.

The power saving mode determination section 225 determines which power saving mode to be selected in accordance with the temperature difference ΔT, and set the selected power saving mode in the frequency varying section 20X (X=1 to 4). As power saving modes, there are power saving mode PS1 and power saving mode PS2. The power saving mode PS1 is a condition in which a clock frequency supplied from the frequency varying section 20X (X=1 to 4) to the core processor is, for example, 80% of the maximum clock frequency. The power saving mode PS2 is a condition in which a clock frequency supplied from the frequency varying section 20X (X=1 to 4) to the core processor is, for example, 60% of the maximum clock frequency.

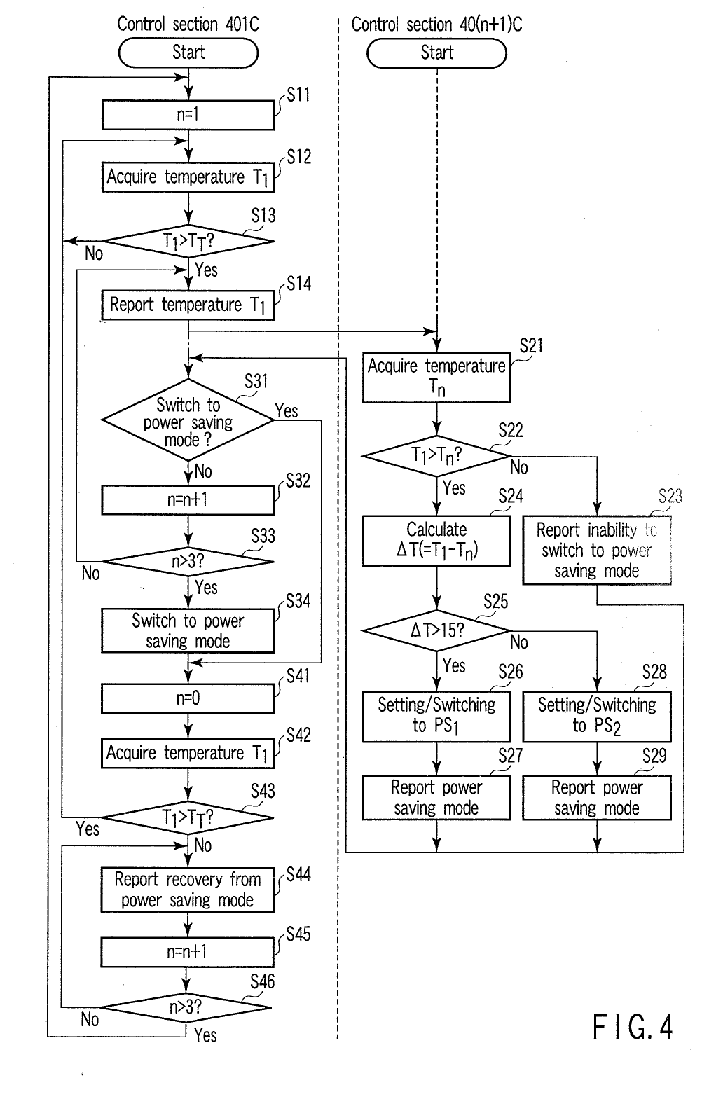

Next, temperature control processing of the control section will be explained with reference to FIG. 4. In the following explanation, the control section 201C of the first core processor 201 will be taken as an example.

First of all, the self-power saving mode control section 222 sets a value n of the counter 222A to one (Step S11). The self-temperature judgment section 221 of the control section 201C requests the DTS 201B to transmit a measured temperature T₁, and acquires measured temperature T₁ from the DTS 201B (Step S12). The self-temperature judgment section 221 of the control section 201C determines if acquired measured temperature T₁ is higher than a threshold temperature T_{N} (Step S13). If measured temperature T₁ is determined not to be higher than temperature T_{N} (No in Step S13), the self-temperature judgment section 221 of the control section 201C goes back to Step S12. If measured temperature T₁ is determined to be higher than temperature T_{N} (Yes in Step 13), the self-temperature judgment section 221 of the control section 201C reports to the self-power saving mode control section 222 of the control section 201C. The self-power saving mode control section 222 of the control section 201C reports the temperature to an Nth processor circuit 20N (Step S14). Incidentally, since the explanation is given according to the correlations between the values of the counter 221 and the semiconductor circuits given above, in the case of the control 201C, N=n+1.

Next, processing of a control section 20NC to which the temperature T_{N} is reported will be explained. The temperature comparison section 223 of the control section 20NC to which the temperature T_{N} is being reported requires that a DTS 20NB transmit the measured temperature T_{N}, and acquires temperature T_{N} from the DTS 20NB (Step S21).

Then, the temperature comparison section 223 of the control section 20NC determines if temperature T₁ is higher than temperature T_{N} (Step S22).

If temperature T₁ is determined not to be higher than temperature T_{N} (No in Step S22), the temperature comparison section 223 of the control section 20NC reports to the self-power saving mode control section 222 of the control section 201C that its own processor circuit 20N is not able to be switched to a power saving mode (Step S23).

If temperature T₁ is determined to be higher than temperature T_{N} (Yes in Step S22), the temperature comparison section 223 of the control section 20NC reports temperature T₁ and temperature T_{N} to the temperature difference arithmetic operation section 224 of the control section 20NC. The temperature difference arithmetic operation section 224 of the control section 20NC performs an arithmetic operation for obtaining the difference ΔT between temperatures T₁ and T_{N} (=T₁-T_{N}) (Step S24). Then, the temperature comparison section 224 reports the temperature difference ΔT to the power saving mode determination section 225.

The power saving mode determination section 225 of the control section 20NC determines if the temperature difference ΔT is greater than 15° C. (Step S25). If the temperature difference ΔT is determined to be greater than 15° C. (Yes in Step S25), setting and switching of a power saving mode PS1 is executed (Step S26).

Processing of Step S26 will be explained. The power saving mode determination section 225 of the control section 20NC sets the power saving mode PS1 in a frequency varying section 20ND of the control section 20NC. The frequency varying section 20ND varies clock frequency supplied to a core processor 20NA to, for example, 80% of the maximum clock frequency in accordance with the setting.

Then, after processing of Step S26, the power saving mode determination section 225 of the control section 20NC reports the power saving mode PS1 to the self-power saving mode control section 222 of the control section 201C (Step S27). Order of Step S26 and Step S27 may be reversed.

If the temperature difference ΔT is determined not to be greater than 15° C. in Step S25 (No in Step S25), setting and switching of power saving mode PS2 is executed (Step S28).

Now, processing of Step S28 will be explained. The power saving mode determination section 225 of the control section 20NC sets a power saving mode PS2 in the frequency varying section 20ND of the control section 20NC. The frequency varying section 20ND varies clock frequency supplied to a core processor 20NA to, for example, 60% of the maximum clock frequency in accordance with the setting.

Then, after processing of Step S28, the power saving mode determination section 225 of the control section 20NC reports the power saving mode PS2 to the self-power saving mode control section 222 of the control section 201C (Step S29). Order of Step S28 and Step S29 may be reversed.

Next, processing of the control section 201C, which is executed after reporting to the self-power saving mode control section 222 of the control section 201C is made in the processing of any of Steps S23, S27, and S29, will be explained.

The self-power saving mode control section 222 of the control section 201C determines if the core processor 20NA is switched to the power saving mode in response to the report made by the control section 20NC (Step S31).

If it is determined that the core processor 20NA is not switched to the power saving mode (No in Step S30), the self-power saving mode control section 222 increases value n of the counter 222A by one (Step S32). Then, the self-power saving mode control section 222 determines if the value n of the counter 222A is greater than a number which is one subtracted from the number of semiconductor circuits, that is 3 (Step S33). If it is determined that the value n of the counter 222A is not greater than 3, the self-power saving mode control section 222 reports temperature T₁ to a next control section 20NC (Step S14), and waits until a report is made by the control section 20NC to which temperature T₁ is reported. The control section 20NC to which temperature T₁ is reported sequentially performs processing from the above mentioned Step S21 onward.

If it is determined that the value n of the counter 222A is greater than 3 in Step S33, the self-power saving mode control section 222 executes setting for switching to a power saving mode in the frequency varying section 201D, and the frequency varying section 201D is thereby switched to the power saving mode (Step S34). Incidentally, the case where the value n of the counter 222A is greater than 3 means the case where none of the other processors 202A to 204A is switched to a power saving mode.

Next, processing to be performed after the processing, where it is determined in Step S31 that the core processor 20NA is switched to a power saving mode (Step S31), or more specifically, the frequency varying section 20ND is switched to the power saving mode (Step S34) and any of the processors 202A-204A is thereby switched to the power saving mode, is explained.

The self-power saving mode control section 222 sets the value n of the counter 222A to zero (Step S41).

The self-temperature judgment section 221 of the control section 201C requests the DTS 201B to transmit temperature T₁ and thereby acquires temperature T₁ from the DTS 201B (Step S42). Incidentally, it is ideal to have this processing executed after a lapse of predetermined time from a point of time at which any of the processor circuit is switched to a power saving mode. It is because it takes time, after a processor circuit being switched to a power saving mode, for the temperature of the switched processor circuit to be stabled.

The self-temperature judgment section 221 of the control section 201C determines if acquired measured temperature T₁ is higher than a threshold temperature T_{N} (Step S43). If measured temperature T₁ is determined not to be higher than temperature T_{N} (No in Step S43), the self-temperature judgment section 221 of the control section 201C goes back to Step S12.

If measured temperature T₁ is determined to be higher than temperature T_{N} (Yes in Step S43), the self-temperature judgment section 221 of the control section 201C reports to the self-power saving mode control section 222 of the control section 201C. The self-power saving mode control section 222 of the control section 201C reports to the Nth processor 20N (N=n+1) that the Nth processor 20N may recover from the power saving mode (Step S44). In the case where n=0, the self-power saving mode control section 222 of the control section 201C reports to its own processor, namely the processor 201, that the processor 201 may recover from the power saving mode.

The power saving mode control section 222 increases value n of the counter 222A by one (Step S45). Then, the self-power saving mode control section 222 determines if the value n of the counter 222A is greater than a number which is one subtracted from the number of semiconductor circuits, that is 3 (Step S46). If it is determined that the value n of the counter 222A is not greater than 3 (No in Step S46), the self-power saving mode control section 222 goes back to Step S44, and reports to the Nth processor 20N (N=n+1) that the Nth processor may recover from the power saving mode (Step S44).

If it is determined in Step S46 that the value n of the counter 222A is greater than 3 (Yes in Step S46), the self-power saving mode control section 222 goes back to Step S11 and executes temperature judgment.

With the foregoing processing, temperature rise of the semiconductor circuits including processor circuits can be suppressed while simultaneously suppressing decline of performance. Furthermore, since the foregoing processing is executed within the processor group 200, user applications need not be redesigned.

If the temperature of a processor circuit is high, a load is imposed on the processor side, not on the user's side. Therefore, performance of the processor inevitably falls if the operation speed of the processor is reduced to reduce the temperature of the processor circuit.

At present, since most software is not compliant with multiprocessor, it is often the case that processing of single software is executed within one processor.

Thus, even if load imposed on a processor circuit is high, it is often the case that loads imposed on other processor circuits are low. Therefore, it becomes possible to further reduce the temperature of a processor circuit having low load, by reducing the operation speed of the processor circuit having low load. Then it becomes easier for the temperature of the processor circuit having high load to be transmitted to the processor circuit having low load. Thus, it is possible to reduce the temperature of the processor having high load without reducing the performance of the processor circuit.

In order to control operation speed, comparison of sizes of loads should be controlled with software. However, according to the embodiment of the present invention, temperatures of the processors are compared instead of presuming sizes of loads.

If temperature of a processor circuit is higher than temperatures of other processor circuits, load of the processor can be presumed to be higher than loads of the other processors. Similarly, if the temperature of a processor circuit is lower than the temperatures of other processor circuits, the load of the processor can be presumed to be lower than the loads of the other processors.

As explained above, according to the present invention, if the temperature of a processor circuit is high, whether or not to switch the processor to a power saving mode for reducing operation speed is determined by reporting the temperature of the processor circuit to other processor circuits and having those processor circuits compare the reported temperature with their own temperatures.

With the comparison of temperatures as is described above, software for transmitting instruction, which makes processor circuits compare loads and reduced operation speed, becomes unnecessary.

Incidentally, as described above, a measured temperature of a processor circuit is sequentially reported to other processors, in order of physical distance from closest to farthest, for checking if it is possible to reduce operation speed of other processor circuits. If the temperature differences between neighboring processor circuits become large, a thermal transition occurs in a processor circuit having an increased temperature, and this eventually causes the advantage that the temperature of all the processor circuits is reduced.

Also, temperature reports are executed via a bus independent from a bus connecting the processor circuits 201-204 and the north bridge 112. The use of the bus dedicated for temperature reports prevents interruption in communications between the processor circuits 201-204 and the north bridge 112, and degradation of the performances of the processor circuits 201-204 is thereby suppressed.

Incidentally, the multicore processor having four processors is taken as an example in the above explanation, multicore processor may include a plurality of processors besides four.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the invention.

What is claimed is:

1. An information processing apparatus comprising a first semiconductor circuit having a first processor circuit and a second semiconductor circuit having a second processor circuit, the information processing apparatus comprising:
a first temperature measurement unit provided in the first semiconductor circuit and configured to measure a temperature of the first semiconductor circuit;
a second temperature measurement unit provided in the second semiconductor circuit and configured to measure a temperature of the second semiconductor circuit;
a first and a second temperature communication units provided in the first and second semiconductor circuits respectively, and configured to send a first temperature of either the first or second semiconductor circuit measured by the first or second temperature measurement unit respectively, to either the second or first semiconductor circuit respectively when the first temperature is higher than a threshold temperature;
a plurality of temperature comparison units provided in the first and second semiconductor circuits respectively, and configured to compare the first temperature and a second temperature measured by the temperature measurement units of the first and second semiconductor circuits, when either the first or second semiconductor circuit receives the second or first temperature sent by the second or first temperature communication units; and
a plurality of operational speed changing units provided in the first and second semiconductor circuits respectively, configured to reduce the operational speed of the processor circuit in the second or first semiconductor circuits respectively, when the received first temperature is higher than the second temperature.

2. The information processing apparatus of claim 1, further comprising a bridge circuit configured to perform communications between the first and second processor circuits respectively provided in the first and second semiconductor circuits via a first bus, wherein
communication of the first measured temperature is performed via a second bus connecting the first and second semiconductor circuits.

3. The information processing apparatus of claim 1, further comprising a third semiconductor circuit having a third processor circuit, wherein
the first or second temperature communication unit is further configured to send the first temperature to the third semiconductor circuit when the operational speed of the semiconductor circuit which received the first temperature is not reduced.

4. The information processing apparatus of claim 3, wherein the first or second temperature communication unit is configured to sequentially send the first temperature to the semiconductor circuits in an ascending order of distance from the semiconductor circuit sending the first temperature.

5. The information processing apparatus of claim 1, wherein the operational speed changing units are configured to reduce clock frequencies of the processor circuits.

6. A control method of a processor circuit comprising:
measuring a temperature T₁ of a first semiconductor circuit using a first temperature measurement unit provided in the first semiconductor circuit having a first processor circuit;
sending the temperature T₁ to a second semiconductor circuit having a second processor circuit when the temperature T₁ is higher than a threshold temperature,
measuring a temperature T₂ of a second semiconductor circuit using a second temperature measurement unit provided in the second semiconductor circuit; and
reducing an operational speed of the second processor circuit, when the temperature T₁ is higher than the temperature T₂.

7. The method of claim 6, wherein
communications between the first and second processors are performed by a bridge circuit via a first bus, and
the communication of the temperature T₁ is performed via a second bus connecting the plurality of semiconductor circuits.

8. The method of claim 6, further comprising:
sending the temperature T₁ to a third semiconductor circuit having a third processor circuit when the temperature T₁ is lower than the temperature T₂;
measuring a temperature T₃ of the third semiconductor circuit using a third measurement unit provided in the third semiconductor circuit; and
reducing an operational speed of the third semiconductor circuit when the temperature T₁ is higher than the temperature T₃.

9. The method of claim 8, wherein the first semiconductor circuit is configured to sequentially send the temperature T₁ to the semiconductor circuits in an ascending order of distance from the first semiconductor circuit.

10. The method of claim 6, wherein a clock frequency supplied to the second processor circuit is reduced for reducing the operational speed of the second processor circuit.
